(19) United States
(12) Patent Application Publication
(10) Pub. No.: US 2017/0024454 A1
(43) Pub. Date: Jan. 26, 2017

(54) DISCOURSE ADVANCEMENT SCORING FOR SOCIAL MEDIA POSTS

(71) Applicant: International Business Machines Corporation, Armonk, NY (US)

(72) Inventors: Jonathan F. Brunn, Logan, UT (US); Jennifer Heins, Raleigh, NC (US); Marc D. Labrecque, Chapel Hill, NC (US); Erika Varga, Harvard, MA (US)

(21) Appl. No.: 14/808,091

(22) Filed: Jul. 24, 2015

(51) Int. Cl. G06F 17/30; H04L 12/58; H04L 29/08

(52) U.S. Cl. CPC G06F 17/30598; H04L 67/22; H04L 67/306; H04L 51/32; H04L 51/16; G06F 17/30864

(57) ABSTRACT

A computer implemented method and system for assessing communications of users on an online social network includes monitoring a plurality of communications of users using electronic devices. Each of the communications correspond to an originating user. Content of the communications is analyzed for uniqueness using a first metric. The first metric including categorizing the content based on uniqueness factors. A uniqueness value of the content of the communications is determined based on the content analysis using the first metric. The communications are analyzed for engagement using a second metric. The second metric includes quantifying the communications based on engagement factors. An engagement value is determined for the communications based on the communications analysis using the second metric. A contribution value is assigned to each of the originating users. The contribution value is based on the uniqueness value and the engagement value of the originating user's communications.

### BACKGROUND

The present disclosure relates to a method and system for assessing social networking communications of users connected on an electronic communications system. Metrics for assessing social media influence or contribution can include measuring the volume of communications or posts on an electronic social network. Such metrics can also include assessing the size of an audience or network of a user, and the number of forwarding of the communications, or affirmations by other users of the communications. Attempts have been made to assign an economic value of communications or posts, or an impact factor or influence based on the ability for a post or poster to sway others. Other metrics measure social media impact, and perception of brands, products, companies, people, and events.

An individual user, for example, within a private organization, a public institution, or a governmental agency, may have a large number of followers or a high engagement related to their current role in the organization more than resulting from the value to the organization of their contribution online. Contrarily, a new user with no followers or network may not have a high engagement of users with a communication or post.

Organizations may strive for their users to contribute new and valuable ideas and insights through their social networks. In one example, an idea blog within an organization may be built for this purpose. However, a specific blog may not be available to a larger audience, and may not incorporate ideas posted to more general social networks within the organization.

### SUMMARY

In one aspect of the present disclosure, a computer implemented method for assessing communications of users on an online social network includes monitoring a plurality of communications of users using electronic devices. The users are connected on a social network using an electronic communications system, each of the communications corresponding to an originating user. The method includes analyzing content of the communications for uniqueness using a first metric, and the first metric includes categorizing the content based on uniqueness factors. A uniqueness value of the content of the communications is determined based on the content analysis using the first metric. The content of the communications for engagement is analyzed using a second metric, and the second metric includes quantifying the communications based on engagement factors. An engagement value for the communications is determined based on the communications analysis using the second metric. The method includes assigning a contribution value to each of the originating users, and the contribution value is based on the uniqueness value and the engagement value of the originating user's communications.

In another aspect of the present disclosure, a computer program product assesses communications of users on an online social network. The computer program product includes a computer readable storage medium having program instructions embodied therewith, wherein the computer readable storage medium is not a transitory signal per se. The program instructions are executable by a computer to cause the computer to perform a method, comprising: monitoring a plurality of communications of users using electronic devices, the users being connected on a social network using an electronic communications system, each of the communications corresponding to an originating user; analyzing content of the communications for uniqueness using a first metric, the first metric including categorizing the content based on uniqueness factors; determining a uniqueness value of the content of the communications based on the content analysis using the first metric; analyzing the content of the communications for engagement using a second metric, the second metric includes quantifying the communications based on engagement factors; determining an engagement value for the communications based on the communications analysis using the second metric; and assigning a contribution value to each of the originating users, the contribution value being based on the uniqueness value and the engagement value of the originating user's communications.

In another aspect of the present disclosure, a computer system assesses communications of users on an online social network. The computer system includes: one or more computer processors, one or more computer-readable storage media, and program instructions stored on one or more of the computer-readable storage media for execution by at least one of the one or more processors. The program instructions, include: monitoring a plurality of communications of users using electronic devices, the users being connected on a social network using an electronic communications system, each of the communications corresponding to an originating user; analyzing content of the communications for uniqueness using a first metric, the first metric including categorizing the content based on uniqueness factors; determining a uniqueness value of the content of the communications based on the content analysis using the first metric; analyzing the content of the communications for engagement using a second metric, the second metric includes quantifying the communications based on engagement factors; determining an engagement value for the communications based on the communications analysis using the second metric; and assigning a contribution value to each of the originating users, the contribution value being based on the uniqueness value and the engagement value of the originating user's communications.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed below.

FIG. 1 is a schematic block diagram illustrating an overview of a system and methodology for assessing communications of users on an online social network according to an embodiment of the disclosure.

FIG. 2 is a flow chart illustrating a method for assessing communications of users on an online social network based on FIG. 1 according to an embodiment of the disclosure.

FIG. 3 is a continuation of the flow chart shown in FIG. 2.

FIG. 4 is a schematic block diagram illustrating a system assessing communications of users on an online social network based on the system and method shown in FIGS. 1-3 according to an embodiment of the disclosure.

FIG. 5 is a schematic block diagram illustrating a social application display in accordance with the system and method shown in FIGS. 1-4.

### DETAILED DESCRIPTION

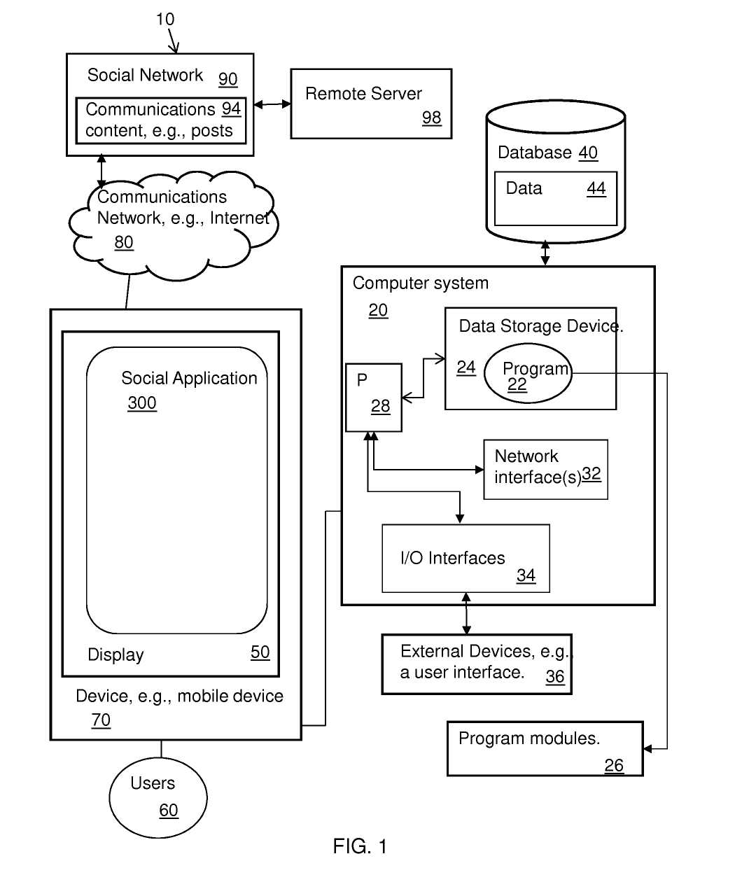

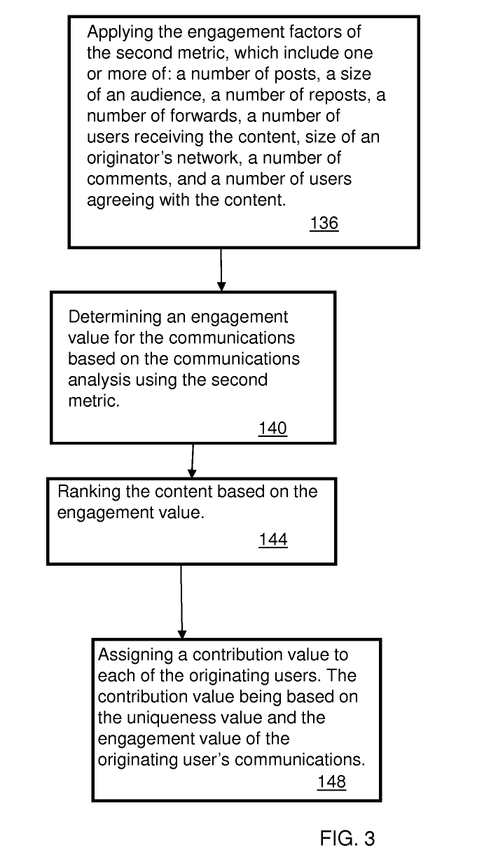

Referring to FIGS. 1-4, a system 10 and a method 100 according to an embodiment of the present disclosure assesses communications of users on an online social network. The method 100 monitors a plurality of communications 94 of users 60 using electronic devices 70, as in block 104. The users 60 are connected on a social network 90 using an electronic communications system embodied as a communications network 80. Each of the communications correspond to an originating user 60. The users can access the social network 90 using a social application 300 which can be presented on a display 50 of their device 70.

For example, a device 70 includes a computer 20. The device 70 can be a mobile device, or another type of computer device. The device 70 includes a display 50 which is viewable by the user 60. The device includes the social application 300 which can access the communications network 80 (e.g., the Internet, a local network) to communicate with the social network 90.

A mobile device is one embodiment of a device having a computer or computer system 20, which is depicted generically in FIG. 1. Other devices having a computer or described as a computer or computer system may include, for example, a Personal Data Assistant (PDA), a cell phone, or a notebook, a desktop computer, or the like. The device in the present disclosure can be configured to send and receive electronic communications. The computer system 20 is a generic representation of a computer which may be embodied in a device such as a hand held device, or can also represent a server for providing the method of the present disclosure as a service which can be accessible using the Internet or a network.

The method 100 includes analyzing content 94 of the communications for uniqueness 212 (or to measure uniqueness) using a first metric 204, as in block 108. The content can include posts, comments, or a blog. A post is used as the primary example of content herein, but is not intended to limit examples of content. It is understood that a post is used generically herein for any kind of communication, including, a blog. The first metric 204 includes categorizing 224 the content 94 based on uniqueness factors 208. For example, application of the first metric can include uniqueness factors to analyze the content, and then to categorize the content. The uniqueness factors can include: a concept, a generality, a refinement, an improvement, an affirmation of an existing post (e.g., like), and a question, as in block 112. After the content is analyzed using the uniqueness factors, the content can be categorized into categories including: an idea, an event, a person, and a question, as in block 116.

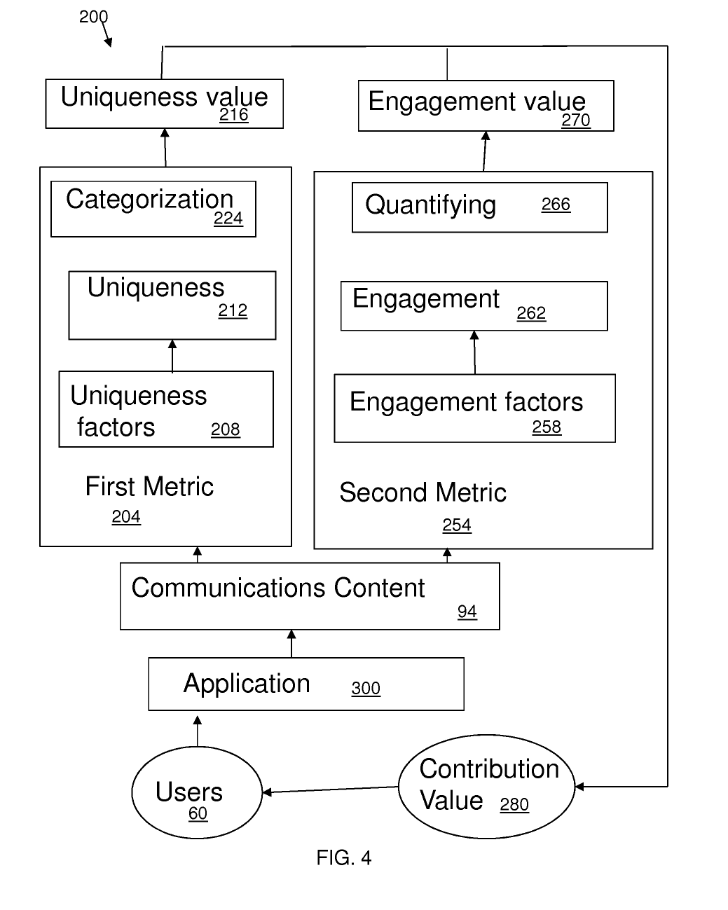

The method 100 includes determining a uniqueness value 216 (FIG. 4) of the communications content 94 based on the content analysis using the first metric 204 (FIG. 4), as in block 120. A system 200 is depicted in FIG. 4, as a functional block diagram, which is in accordance with the method of the present disclosure referred to in FIGS. 1-3.

Referring to FIGS. 1 and 4, the content 94 can be ranked based on the uniqueness value 216, as in block 124. The method 100 further includes analyzing the communications content 94 for engagement 262 using a second metric 254, as in block 128. The second metric includes quantifying 266 the communications content based on engagement factors 258, as in block 132.

For example, the engagement factors can include one or more of: a number of posts, a size of an audience, a number of reposts, a number of forwards, a number of users receiving the content, size of an originator's network, a number of comments, and a number of users agreeing with the content, as in block 136.

The method 100 includes determining an engagement value 270 for the communications based on the communications analysis using the second metric, as in block 140.

Referring to FIG. 1, the content 94 can be ranked based on the engagement value 270, as in block 144. For example, the content which has the highest engagement value can be the content with the highest engagement of the user based on the engagement factors. For instance, the most forwards, reposts, affirmations or likes, etc. Thus, the content with the most engagement of the users would have the highest engagement value.

A contribution value 280 is assigned to each of the originating users 60, as in block 148. The contribution value is based on the uniqueness value and the engagement value of the originating user's communications.

In one example, the contribution value can include the average of the uniqueness value and the engagement value. In another example, value can be attributed to ideas and concepts more than engagement or volume of posts or reposts. Thus, the above approach rewards those with smaller networks or a smaller number of posts, but which have an idea or contribution having a significant impact. In another example, the number of posts and reposts can be ascertained to determine a quantity, and a number of times a user's idea in the original post or original post is cited or referred to in other users' posts can be ascertain. The combination of the quantity and the number of times the user's idea is cited can be combined to provide a final score reflecting quantity and influence of a user's post or user's idea. An idea or post can also time out so that a user is not rewarded for old posts or ideas.

In one example, a user can have a score of at least n if the user has a(n) posts of score n in a time period b(n), where a(n) and b(n) are tunable methods which allow the number of posts necessary to achieve a score, and the time allowed to achieve that score, to vary based on the score. One such implementation is a(n)=n*a and b( )=n*b+c where a, b, and c are positive real numbers. One implementation to find n can be a binary search over possible or expected values of n, the score, applying the configurable a(n) and b(n) functions. Another more simple metric would be to take the average of the user's top scoring X posts, where X is tunable.

In one embodiment according to the present disclosure, the method 100 may be embodied in a program 22 (FIG. 1) embodied on a computer readable storage device, e.g., data storage device 24. The program 22 is executable by a processor 28 of a computer system 20 (to execute program steps, code, or program code). Additional data storage may also be embodied as a database 40 including data 44. The program or executable instructions may be offered as a service by a provider. The computer 20 and program 22 shown in FIG. 1 are generic representations of a computer and program that may be local to a user, or provided as a remote service, such as website accessible using a network (e.g., interacting with the Internet or cloud services). It is understood that the computer 20 also generically represents herein a computer device or a computer included in a device, such as a laptop or desktop computer, etc., or one or more servers, alone or as part of a datacenter. The computer system 20 can include a network interface 32, and input/output (I/O) interface(s) 34. The I/O interface 34 allows for input and output of data with an external device 36 that may be connected to the computer system. The network interface 32 may provide communications between the computer system and a computer network. The method steps and system components and techniques may be embodied in modules of the program 22 for performing the tasks of each of the steps of the method and system, which are generically represented in FIG. 1 as program modules 26. The program 22 and program modules 26 can execute specific steps, routines, sub-routines, instructions or code, of the program. The method of the present disclosure can be run locally on a device such as the mobile device, or can be run a service, for instance, on a remote server 98 which is accessed using the communications network 80.

It is understood that a computer or a program running on the computer may communicate with a server computer via a communications network. The communications network may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

The electronic communications system can be selected from a group including: instant messaging (IM), short message services (SMS), a blog, a web site, a community or social community, a news feed, and an email.

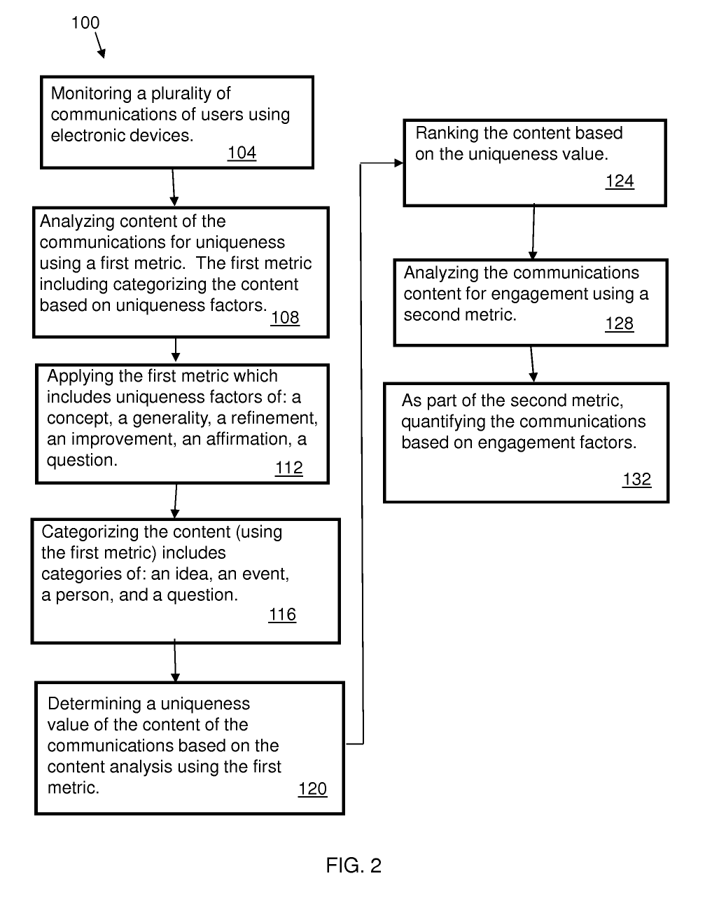

In another embodiment, the classifications or categories determined for content in step 116 (FIG. 2) can be used to determine recipients of the content. For example, a person/user can be designated to receive a communication with content classified as an idea, and another user can be designated to receive a communication with content classified as an event.

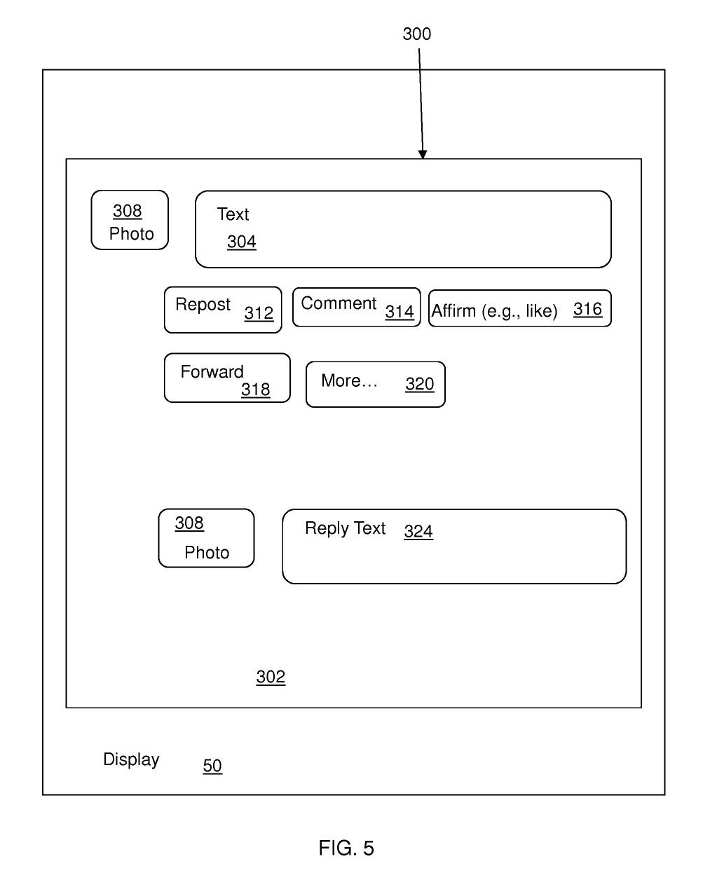

Referring to FIG. 5, in one embodiment according to the present disclosure, a social application 300 is viewable on the display 50 of the device 70 (FIG. 1).

Generally, the present disclosure includes using a semantic analysis to look at the content of a communication, i.e., a post. In one instance, keywords and the proximity of those keywords to names of individuals are used to identify when a post is about a person (for example, announcing a promotion, award, birthday, accomplishment or retirement).

If a post is not about a person, keywords and semantic analysis can be used to see if the post is about an event. For example, if the post is about a project deadline, product release, release of an advertising promotion, conference, etc.

If a post is not about a person or event, keywords and semantic analysis can be used to see if the post is about a question. The highest value questions are those that spark conversation around unique solutions and ideas. Questions about people and events are lower value.

If the post does not fall into one of the above categories, the post can be analyzed to determine if it represents a new idea. For example, replies to the post can indicate that a post is an idea by including certain key words. The key words can include, for example: idea, or implement. Key phrases can indicate that a post includes an idea. Example key phrases can include: ‘that's a good idea’, or ‘we should implement that’.

Posts that are not classified as one of the categories above can be, for example, classified or organized using other techniques, or not classified or organized at all.

In one embodiment of the present disclosure, the posts within a category can be ranked in order of engagement. Engagement can be determined by the number of time other users engage the content, for example: comment, affirm or like, repost or forward the original post.

In one embodiment according to the present disclosure, categories of content of communications (e.g., posts) can be further analyzed, for example by comparison and/or further categorization. For instance, the content of a post can be compared to prior posts to determine the originality of the idea. To compare posts, the method can search the content for neologisms and pairings or groupings of words in the same sentence which appear uncommon in the corpus, but have recently appeared in multiple posts. The method can further inquire if the content (e.g., text or media) of the post was copied from other available sources or if the content first appeared in the post, which lends credibility to the conclusion that the content is unique.

In one embodiment according to the present disclosure, a relative engagement value can be assessed. The engagement on a post can be measured both absolutely and relative to the network of the contributor. For example, measuring the number of engagements by other users (e.g., affirmations/likes, reports, comments on a post, etc.). Further, a number of engagements can be compared to the size of a user's network and adjusted. For example, a user with a modest amount of engagements can be awarded an engagement score based on the amount of engagements compared to the size of their network to assign a relative engagement value.

The above can apply to an engagement score and a contribution value and the approach can give individuals with small networks recognition for their contribution and the opportunity for recognition by contributing posts which may generate a wide reach and affect. The high engagement score can be used as a threshold to share a post with a larger network, outside the originating users network. For example, with a larger part of an organization which the originator belongs to. In this manner, creative, original ideas can be shared with a larger group within an organization that it normally would based on a person's network.

In one embodiment, the results of the analysis described above leading to the contribution value, can be used to decide which posts to preferentially include in email notifications and on news feeds when more posts exist in a network than may be displayed. Original ideas may also be given preferential treatment.

In another embodiment, posts about people may appear in a separate section from posts about ideas. Posts about events may be tied to a calendar view as a method of presentation of these posts, and posts about ideas can be more prominently display (e.g., centrally displayed).

In one embodiment of the present disclosure, content receiving a contribution value can be a post classified as an idea or question, deemed unique or original and can receive extensive engagement within the contributor's network, and thus be promoted to others outside the contributor's network. This can foster greater sharing of ideas and forging new relationships across an organization.

A user's contribution value can be used to rank and promote future posts of the user. In another example, delivery of an idea as opposed to an event can be prioritized. Additionally, a user having a high contribution value can have their posts prioritized. In another example, posts about ideas can be sent to users when a receiver has time on their calendar to allow them time to review and understand the post.

Referring to FIG. 5, an example communication 302 is presented using a social application 300, displayed on the display 50 the device 70 (FIG. 1). An originating user can post text 304 and a photo 308 can be supplied. The application can include buttons for: a repost 312, a comment 314, an affirm or like 316, to forward 318, and more actions 320. Another user can respond with reply text 324. The text 304 can include reference to an idea, event, or a person, or the reply text 324 could include such references or other keywords that can assist in classifying the content such as: award, congratulations, event, or question.

The present disclosure uses categorization of content in electronic communications as ideas, event, and people to begin to score and classify social media posts, in ascertaining their effect on discourse and value to the organization, and rank the contributor.

In one example, posts about people (e.g., promotions, retirements, birthdays, etc.) may have extremely high engagement, but very low impact to increasing revenue for the organization. A certain number may be necessary for corporate communications and moral, but they can quickly drown out more substantial conversations.

Embodiments of the present disclosure classifies each post as to whether it is about an idea, event, person, or question, and also ascertains more traditional metrics as well. The present disclosure can assign scores to individuals based on the classification of the posts combined with the additional metrics (e.g., comments, forwards, affirmation, etc.). Thus, the present disclosure incorporates a technique to measure a value of a post and communication to an organization, not only engagement quantity, but also to ascertain engagement of a user relative to the network of the contributor and the value of the posts to the organization which can be based on the posts uniqueness. Thus a user with a small network can still have their engagement recognized and receive a relatively high recognition of their contribution using a value score.

Continuing in relation to the embodiment above, the value of a post to an organization which includes not only engagement quantity, but also includes capturing originality of a post including whether a post generates or captures an idea or a new idea. A value can be assigned to a post that captures a new idea that reflects it greater value to an organization. The post can be shared with an organization because of its higher value and thus influence a social group larger than an individual's social group or network. Thus the post is promoted outside the user's network based on the value assigned to the post.

Thereby, in one embodiment of the method and system of the present disclosure, selected content of a social group within a larger social group can be shared with the larger group within a social network based on the uniqueness value. For example, a small network within an organization can have a user post content which receives a high uniqueness value. The content can be shared with a larger part of the organization or the whole organization based on its high uniqueness value because the selected content has been assigned a high uniqueness value and the user may also have a high contribution value. The uniqueness value can be required to meet or exceed a threshold value for sharing the selected content with a larger group.

In another example, a user may have a first network which is small compared to their organization network which is a second network. The user posts comments within the first network and the content receives a high uniqueness value. Based on the uniqueness value, the content can be shared with the second network. This technique can provide valuable interaction within the organization by introducing high value content into a larger network within the organization, which would not normally be circulated outside a smaller group, in this example, the first network.

Referring to FIG. 1, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A computer implemented method for assessing communications of users on an online social network, comprising:
monitoring a plurality of communications of users using electronic devices, the users being connected on a social network using an electronic communications system, each of the communications corresponding to an originating user;
analyzing content of the communications for uniqueness using a first metric, the first metric including categorizing the content based on uniqueness factors;
determining a uniqueness value of the content of the communications based on the content analysis using the first metric;
analyzing the content of the communications for engagement using a second metric, the second metric includes quantifying the communications based on engagement factors;
determining an engagement value for the communications based on the communications analysis using the second metric; and
assigning a contribution value to each of the originating users, the contribution value being based on the uniqueness value and the engagement value of the originating user's communications.

2. The method of claim 1, wherein the categorizing of the content using the first metric includes categories of: an idea, an event, a person, and a question.

3. The method of claim 2, further comprising:
communicating selected content to a designated user based on the category of the content.

4. The method of claim 1, wherein the uniqueness factors of the first metric include: a concept, a generality, a refinement, and an improvement.

5. The method of claim 1, further comprising:
ranking the content based on the uniqueness value.

6. The method of claim 1, further comprising:
sharing selected content of the content of the communications originating from a user, with a larger group within the social network than the user's group, based on the uniqueness value.

7. The method of claim 6, wherein the user's group is part of a first network of users within an organization, and the larger group is part of a second network of users within the organization which is larger than the first group, and the uniqueness value meets or exceed a threshold value for sharing the selected content with the larger group.

8. The method of claim 1, wherein the engagement factors of the second metric include one or more of: a number of posts, a size of an audience, a number of reposts, a number of forwards, a number of users receiving the content.

9. The method of claim 1, wherein the engagement factors of the second metric include:
a size of an originator's network, a number of comments, and a number of users agreeing with the content.

10. The method of claim 1, further comprising:
ranking the content based on the engagement value.

11. The method of claim 1, wherein the electronic communications system is selected from a group including: instant messaging (IM), short message services (SMS), a blog, a web site, a community, a news feed, and an email.

12. A computer program product for assessing communications of users on an online social network, the computer program product comprising a computer readable storage medium having program instructions embodied therewith, wherein the computer readable storage medium is not a transitory signal per se, the program instructions executable by a computer to cause the computer to perform a method, comprising:
monitoring a plurality of communications of users using electronic devices, the users being connected on a social network using an electronic communications system, each of the communications corresponding to an originating user;
analyzing content of the communications for uniqueness using a first metric, the first metric including categorizing the content based on uniqueness factors;
determining a uniqueness value of the content of the communications based on the content analysis using the first metric;
analyzing the content of the communications for engagement using a second metric, the second metric includes quantifying the communications based on engagement factors;
determining an engagement value for the communications based on the communications analysis using the second metric; and
assigning a contribution value to each of the originating users, the contribution value being based on the uniqueness value and the engagement value of the originating user's communications.

13. The computer program product of claim 12, wherein the categorizing of the content using the first metric includes categories of: an idea, an event, a person, and a question.

14. The computer program product of claim 12, wherein the uniqueness factors of the first metric include: a concept, a generality, a refinement, and an improvement.

15. The computer program product of claim 12, further comprising:
sharing selected content of the content of the communications originating from a user, with a larger group within the social network than the user's group, based on the uniqueness value.

16. The computer program product of claim 15, wherein the user's group is part of a first network of users within an organization, and the larger group is part of a second network of users within the organization which is larger than the first group, and the uniqueness value meets or exceed a threshold value for sharing the selected content with the larger group.

17. A computer system for assessing communications of users on an online social network, the computer system comprising:
one or more computer processors, one or more computer-readable storage media, and program instructions stored on one or more of the computer-readable storage media for execution by at least one of the one or more processors, the program instructions, comprising:
monitoring a plurality of communications of users using electronic devices, the users being connected on a social network using an electronic communications system, each of the communications corresponding to an originating user;
analyzing content of the communications for uniqueness using a first metric, the first metric including categorizing the content based on uniqueness factors;
determining a uniqueness value of the content of the communications based on the content analysis using the first metric;
analyzing the content of the communications for engagement using a second metric, the second metric includes quantifying the communications based on engagement factors;
determining an engagement value for the communications based on the communications analysis using the second metric; and
assigning a contribution value to each of the originating users, the contribution value being based on the uniqueness value and the engagement value of the originating user's communications.

18. The system of claim 17, wherein the categorizing of the content using the first metric includes categories of: an idea, an event, a person, and a question.

19. The system of claim 18, further comprising:
communicating selected content to a designated user based on the category of the content.

20. The system of claim 17, wherein the uniqueness factors of the first metric include: a concept, a generality, a refinement, and an improvement.
